(19) United States
(12) Patent Application Publication
(10) Pub. No.: US 2024/0383320 A1
(43) Pub. Date: Nov. 21, 2024

(54) COVERS FOR SHIELDING WINDSHIELD WIPERS AND DOOR HANDLES FROM ICE AND SNOW

(71) Applicant: Charles B. Owens, Davenport, IA (US)

(72) Inventor: Charles B. Owens, Davenport, IA (US)

(21) Appl. No.: 18/198,824

(22) Filed: May 17, 2023

(51) Int. Cl. B60J 11/06; B60S 1/04

(52) U.S. Cl. CPC B60J 11/06; B60S 1/0491

(57) ABSTRACT

A cover system for shielding automobile parts from ice and snow includes an automobile part and a sleeve covering the automobile part. The sleeve comprises a tubular wall which is elongated and bounds an interior space. A portion of the automobile part is positioned in the interior space. The tubular wall has a slit extending across an entirety of a length of the tubular wall through the tubular wall to the interior space through which the automobile part is movable.

### CROSS-REFERENCE TO RELATED APPLICATIONS

Not applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to protective covers and more particularly pertains to a new protective cover for shielding automobile parts from ice and snow.

### (2) Description of Related Art Including Information Disclosed Under 37 CFR 1.97 and 1.98

The prior art describes several apparatuses for shielding automobile parts from ice and snow, particularly including apparatuses for covering wipers and door handles. Wiper covers of the prior art include sleeves with openings on one end for inserting a free end of a wiper into the sleeve. The prior art does not disclose a wiper cover which receives a wiper through a slit which extends a full length of the sleeve. Such an apparatus is desirable in that the wiper does not need to be moved away from the windshield so that the wiper may be inserted into the sleeve. Door handle covers in the prior art include a rigid housing for magnetically adhering to a door over the door handle. Such a design is not workable for many automobile door handles which have a large gap surrounding an elongate rod-like door handle. The new sleeve described for use on the wiper is also usable to protect a wide variety of door handles including rod-like door handles with large gaps surrounding them.

### BRIEF SUMMARY OF THE INVENTION

An embodiment of the disclosure meets the needs presented above by generally comprising an automobile part and a sleeve covering the automobile part. The sleeve comprises a tubular wall which is elongated and bounds an interior space. A portion of the automobile part is positioned in the interior space. The tubular wall has a slit extending across an entirety of a length of the tubular wall through the tubular wall to the interior space through which the automobile part is movable.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a sleeve of a cover system according to an embodiment of the disclosure.

FIG. 2 is a side view of the sleeve of an embodiment of the disclosure.

FIG. 3 is a front view of the sleeve of an embodiment of the disclosure.

FIG. 4 is a back view of the sleeve of an embodiment of the disclosure.

FIG. 5 is a cross-section view of the sleeve of an embodiment of the disclosure taken from Arrows 5-5 in FIG. 4.

FIG. 6 is an exploded view of an embodiment of the disclosure.

FIG. 7 is a perspective view of an embodiment of the disclosure.

FIG. 8 is a side view of an embodiment of the disclosure.

### DETAILED DESCRIPTION OF THE INVENTION

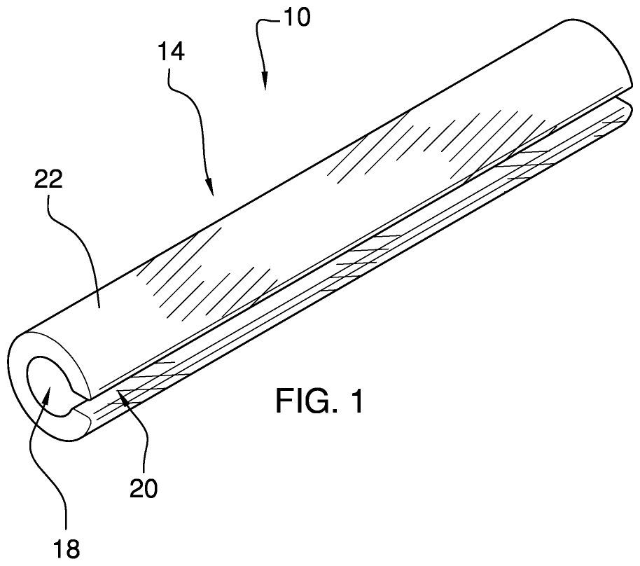

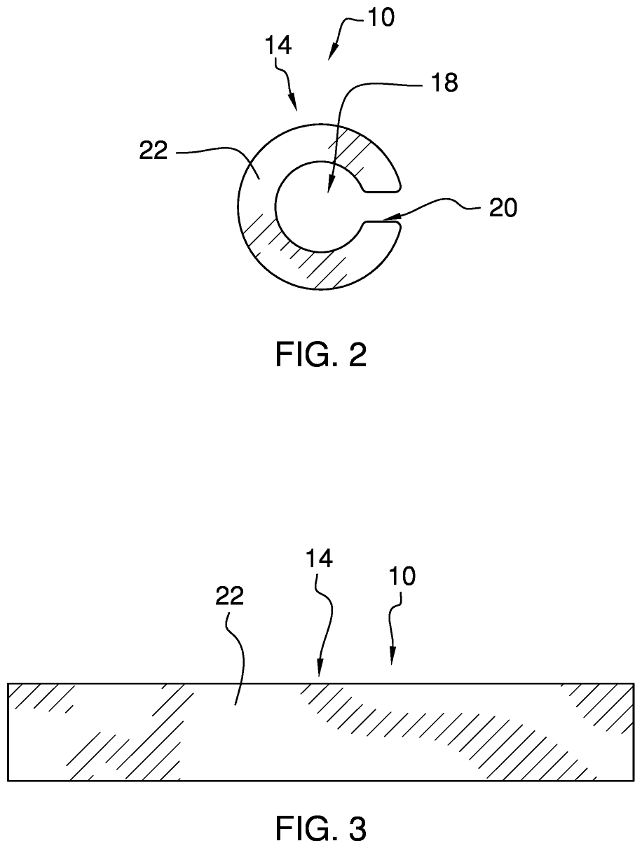

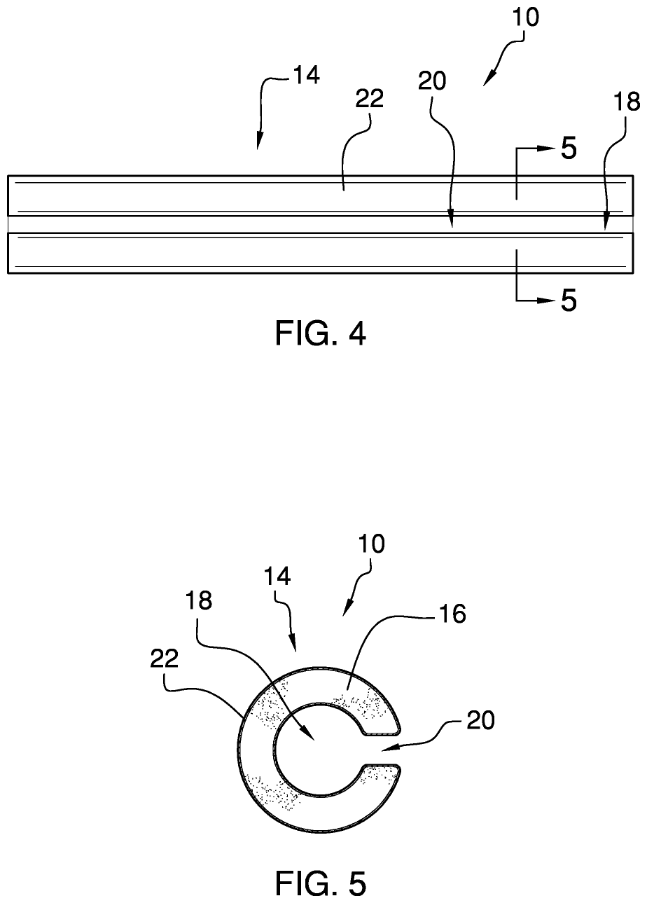

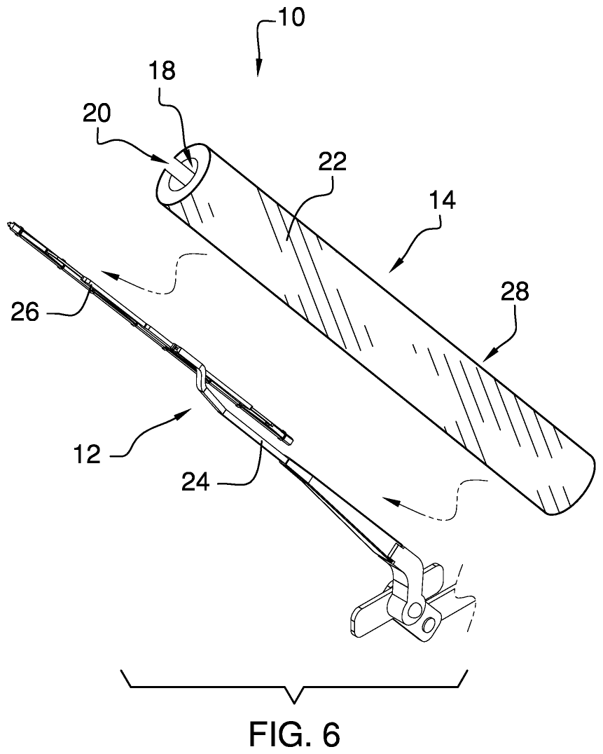

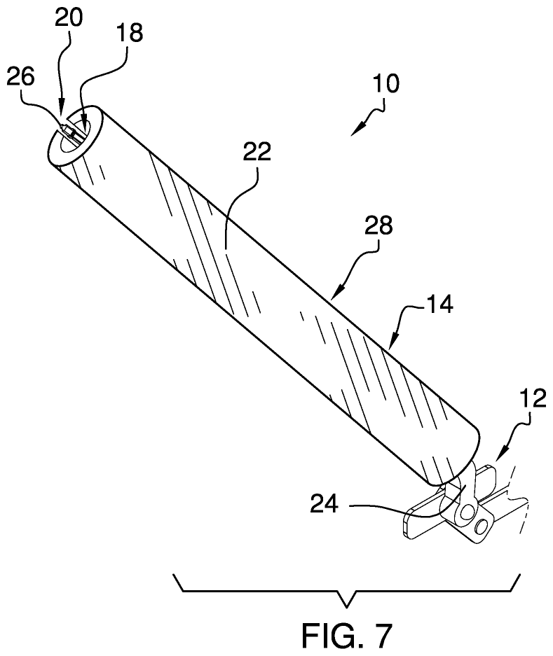

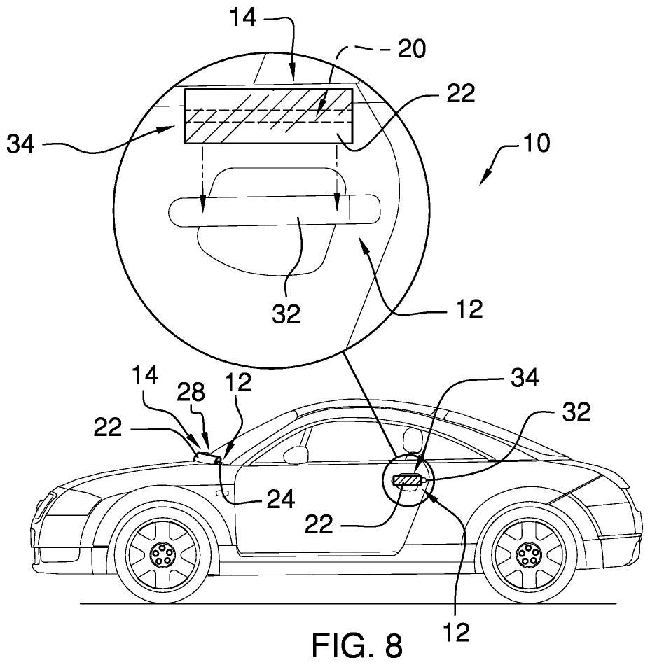

With reference now to the drawings, and in particular to FIGS. 1 through 8 thereof, a new protective cover embodying the principles and concepts of an embodiment of the disclosure and generally designated by the reference numeral 10 will be described.

As best illustrated in FIGS. 1 through 8, the cover system 10 generally comprises an automobile part 12 and a sleeve 14 covering the automobile part 12. The sleeve 14 comprises a tubular wall 16 which is elongated. The tubular wall 16 bounds an interior space 18 in which a portion of the automobile part 12 is positioned. The tubular wall 16 has a slit 20 extending across an entirety of a length of the tubular wall 16 through the tubular wall 16 to the interior space 18, and the automobile part 12 is movable through the slit 20.

The tubular wall 16 comprises a resiliently bendable material such that the slit 20 is expandable to receive the automobile part 12 therethrough. The resiliently bendable material is also thermally insulating such that the tubular wall 16 inhibits heat transfer away from the automobile part 12. The resiliently bendable material is a polymer foam but may comprise any conventional material or combination of materials that is resiliently bendable and thermally insulating. For example, a glass wool may be used to thermally insulate the automobile part 12 while a polymer or metal material may be shaped so as to be sufficiently resiliently bendable so that the slit 20 is expandable as described.

The automobile part 12 is elongated, and the sleeve 14 extends along at least 75 percent of a length of the automobile part 12. The sleeve 14 further comprises a casing 22 enclosing the tubular wall 16. The casing 22 comprises a water-impermeable material such as acrylic, polyvinylchloride, or the like.

In some embodiments, the automobile part 12 is a wiper 24 with a wiper blade 26, and the sleeve 14 is a wiper sleeve 28. In such embodiments, the wiper blade 26 of the wiper 24 extends through the slit 20, and the wiper blade 26 is configured to be positionable in abutment with a windshield 30 through the slit 20. In other embodiments, the automobile part 12 is a door handle 32, and the sleeve 14 is a handle sleeve 34.

In use, the sleeve 14 covers the automobile part 12 and shields the automobile part 12 from snow, ice, and water which may accumulate on the automobile part 12 and damage the automobile part 12. The sleeve 14 also insulates the automobile part 12 to slow a cooling of the automobile part 12 when the automobile part 12 is in a cold environment.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cover system comprising:
an automobile part; and
a sleeve covering the automobile part, the sleeve comprising a tubular wall being elongated, the tubular wall bounding an interior space, a portion of the automobile part being positioned in the interior space, the tubular wall having a slit extending across an entirety of a length of the tubular wall through the tubular wall to the interior space, the automobile part being movable through the slit.

2. The system of claim 1, wherein the tubular wall comprises a resiliently bendable material such that the slit is expandable to receive the automobile part therethrough.

3. The system of claim 2, wherein the resiliently bendable material is thermally insulating such that the tubular wall inhibits heat transfer away from the automobile part.

4. The system of claim 2, wherein the resiliently bendable material is a polymer foam.

5. The system of claim 1, wherein the sleeve further comprises a casing enclosing the tubular wall, the casing comprising a water-impermeable material.

6. The system of claim 1, wherein the automobile part is elongated, the sleeve extending along at least 75 percent of a length of the automobile part.

7. The system of claim 1, wherein:
the automobile part is a wiper having a wiper blade; and
the sleeve is a wiper sleeve, the wiper blade of the wiper extending through the slit, the wiper blade being configured to be positionable in abutment with a windshield through the slit.

8. The system of claim 1, wherein the automobile part is a door handle, the sleeve being a handle sleeve.

9. A cover system comprising:
an automobile part, the automobile part being elongated; and
a sleeve covering the automobile part, the sleeve comprising:
a tubular wall being elongated, the tubular wall bounding an interior space, a portion of the automobile part being positioned in the interior space, the tubular wall having a slit extending across an entirety of a length of the tubular wall through the tubular wall to the interior space, the automobile part being movable through the slit; the tubular wall comprising a resiliently bendable material such that the slit is expandable to receive the automobile part therethrough, the resiliently bendable material being thermally insulating such that the tubular wall inhibits heat transfer away from the automobile part, the resiliently bendable material being a polymer foam, the sleeve extending along at least 75 percent of a length of the automobile part; and
a casing enclosing the tubular wall, the casing comprising a water-impermeable material.

10. The system of claim 9, wherein:
the automobile part is a wiper having a wiper blade; and
the sleeve is a wiper sleeve, the wiper blade of the wiper extending through the slit, the wiper blade being configured to be positionable in abutment with a windshield through the slit.

11. The system of claim 9, wherein the automobile part is a door handle, the sleeve being a handle sleeve.
